(19) United States
(12) Patent Application Publication
(10) Pub. No.: US 2021/0042817 A1
(43) Pub. Date: Feb. 11, 2021

(54) METHODS AND SYSTEMS FOR ORDER ALLOCATION

(71) Applicant: BEIJING DIDI INFINITY TECHNOLOGY AND DEVELOPMENT CO., LTD., Beijing (CN)

(72) Inventor: Junqin LI, Beijing (CN)

(73) Assignee: BEIJING DIDI INFINITY TECHNOLOGY AND DEVELOPMENT CO., LTD., Beijing (CN)

(21) Appl. No.: 17/078,074

(22) Filed: Oct. 22, 2020

Related U.S. Application Data
(63) Continuation of application No. PCT/CN2019/083881, filed on Apr. 23, 2019.

(30) Foreign Application Priority Data
Apr. 23, 2018 (CN) 201810368900.X

(51) Int. Cl. G06Q 30/06; G06Q 30/00; G06Q 10/10; G06Q 30/02; G06Q 40/00; G06Q 50/30; G06N 3/04

(52) U.S. Cl. CPC G06Q 30/0635; G06Q 30/016; G06Q 30/0605; G06N 3/04; G06Q 30/0282; G06Q 40/12; G06Q 50/30; G06Q 10/10

(57) ABSTRACT

The present disclosure provides methods and systems for order allocation. The method may include identifying a service provider for a first service type to whom an order for a second service type is to be allocated. The method may also include identifying a target order for the second service type from a requester based on a screening criteria. The screening criteria may at least include that the requester is an infrequent user of the first service type. The method may further include allocating the target order for the second service type to the service provider for the first service type.

### CROSS-REFERENCE TO RELATED APPLICATION

This application is a continuation of International Application No. PCT/CN2019/083881 filed on Apr. 23, 2019, which claims priority of Chinese Patent Application No. 201810368900.X filed on Apr. 23, 2018, the entire contents of each of which are hereby incorporated by reference in their entirety.

### TECHNICAL FIELD

The present disclosure relates to the technical field of Internet applications, and in particular, to methods and systems for order allocation.

### BACKGROUND

A new Online to Offline (O2O) business model has emerged with the continuous development of Internet technology and the combination of offline business opportunities and the Internet in recent years, making the Internet a platform for offline transactions. Currently, O2O has entered a stage of rapid development, among which the O2O service of vehicles is comparatively successful. The O2O service of vehicles may include different types/levels of service, such as an express service, a tailored car service, a hitchhiking service, a taxi hailing service, a chauffeur service, a carpool service, a bus service, a driver hire service, a shuttle service, or the like.

In some embodiments, the different types/levels of service are not equivalently demanded. For example, since the tailored car service may be aimed at higher-end users, the demand for the tailored car service may be lower than the demand for the express service. In some cases, there may be little demand for the tailored car service, which may make vehicles that provide the tailored car service idle for a long time, thus reducing the utilization of the whole service resources. It is desired to develop systems and methods to coordinate the different types/levels of services to maintain an efficient operation of the whole service resources.

### SUMMARY

According to an aspect of the present disclosure, a system is provided. The system may include at least one storage medium including a set of instructions for allocating orders in an on-demand service and logic circuits in communication with the at least one storage medium. When executing the set of instructions, the logic circuits may be to identify a service provider associated with a first level of a service. The service provider may be available to provide a second level of the service if allocated. The logic circuits may be further to identify, based on a screening criteria, a target order requesting the second level of the service from a requester, the screening criteria including that the requester is an infrequent user of the first level of the service. And the logic circuits may be further to allocate the target order to the service provider for providing the first level of the service.

In some embodiments, the first level of the service and the second level of the service may be associated with at least one of different prices or different service qualities.

In some embodiments, to determine that the requester is an infrequent user of the first level of the service, the logic circuits may be to retrieve historical orders of the requester. The logic circuits may be further to determine a count of orders for the first level of the service or a proportion of orders for the first level of the service based on the historical orders. And the logic circuits may be further to determine that the requester is an infrequent user of the first level of the service if the count of orders for the first level of the service or the proportion of orders for the first level of the service in the historical orders is smaller than a first threshold value.

In some embodiments, the screening criteria may further include that the requester is a potentially frequent user of the first level of the service.

In some embodiments, to determine that the requester is a potentially frequent user of the first level of the service, the logic circuits may be directed to extract feature information of the historical orders of the requester. The logic circuits may be further directed to input the feature information into a trained model to obtain an output result that indicates whether the requester is the potentially frequent user of the first level of the service. And the logic circuits may be further directed to determine that the requester is the potentially frequent user of the first level of the service type if the output result is greater than a second threshold.

In some embodiments, the feature information of the historical orders of the requester may comprise at least one of: a total amount of the historical orders of the requester, a distribution of orders for different service levels in the historical orders of the requester, service charges of one or more of the historical orders of the requester, or service evaluations of one or more of the historical orders of the requester.

In some embodiments, the trained model may comprise at least one of: a Logistic Regression (LR) model, a Decision Tree model, or a Neural Network model.

In some embodiments, the first level of the service and the second level of the service may be both online to offline services of vehicles.

In some embodiments, the first level of the service may be superior to the second level of the service.

According to another aspect of the present disclosure, a method for order allocation is provided. The method may include determining to allocate a target order by a service requester requesting a second level of service to a target service provider providing a first level of the service. The method may further include determining whether the service requester is an infrequent user of the first level of the service. And the method may further include allocating the target order to the target service provider at least partially in response to determining that the service requester is the infrequent user.

In some embodiments, the allocating the target order to the target service provider at least partially in response to determining that the service requester is the infrequent user may comprise determining whether the service requester is a potentially frequent user of the first level of the service in response to determining that the service requester is the infrequent user, and allocating the target order to the target service provider responsive to determining that the service requester is the potentially frequent user.

In some embodiments, the method may further include obtaining target data comprising historical orders of the service requester in a preset time period. The determining whether the service requester is an infrequent user of the first level of the service may comprise determining whether the service requester is the infrequent user based on the target data. And the determining whether the service requester is a potentially frequent user of the first level of the service may comprise determining whether the service requester is the potentially frequent user based on the target data.

In some embodiments, the determining whether the service requester is the frequent user based on the target data may comprise determining at least one of a count of orders for the first level of the service or a proportion of orders for the first level of the service based on the historical orders in the target data, and determining that the service requester is the frequent user if at least one of the count of orders for the first level of the service or the proportion of orders for the first level of the service is greater than or equal to a preset threshold.

In some embodiments, the determining whether the service requester is the potentially frequent user based on the target data may comprise extracting feature information of the target data, inputting the feature information into a trained model to obtain an output probability value, and determining that the service requester is the potentially frequent user if the output probability value is greater than or equal to a preset probability value.

In some embodiments, the feature information may comprise one or more of: feature information of a total amount of the historical orders, feature information of a distribution of orders for different levels of service in the historical orders, feature information of service charges of the historical orders, or feature information of service evaluations of the historical orders.

In some embodiments, the trained model may comprise at least one of: a Logistic Regression (LR) model, a Decision Tree model, or a Neural Network model.

In some embodiments, the first level of the service and the second level of the service may be both online to offline services of vehicles.

According to yet another aspect of the present disclosure, a system for order allocation is provided. The system may comprise at least one storage medium including a set of instructions for allocating orders in an on-demand service, and logic circuits in communication with the at least one storage medium. When executing the set of instructions, the logic circuits may be to determine to allocate a target order by a service requester requesting a second level of service to a target service provider providing service of a first level of the service. The logic circuits may be further to determine whether the service requester is an infrequent user of the first level of the service. And the logic circuits may be further to allocate the target order to the target service provider at least partially in response to determining that the service requester is the infrequent user.

According to still another aspect of the present disclosure, a computer readable storage medium storing instructions is provided. The instructions, when executed by a system, may cause the system to implement a method. The method may comprise determining to allocate a target order by a service requester requesting a second level of service to a target service provider providing a first level of the service. The method may further comprise determining whether the service requester is an infrequent user of the first level of the service. And the method may further comprise allocating the target order to the target service provider at least partially in response to determining that the service requester is the infrequent user.

According to still another aspect of the present disclosure, an electronic device is provided. The electronic device may comprise a processor and a storage device configured to store a plurality of instructions. The instructions may be configured to be loaded and executed by the processor to determine to allocate a target order by a service requester requesting a second level of service to a target service provider providing a first level of the service. The instructions may be further configured to be loaded and executed by the processor to determine whether the service requester is an infrequent user of the first level of the service. And the instructions may be further configured to be loaded and executed by the processor to allocate the target order to the target service provider at least partially in response to determining that the service requester is the infrequent user.

### BRIEF DESCRIPTION OF THE DRAWINGS

The drawings herein are incorporated into the specification and form a part of this specification. The embodiments of the present disclosure are shown and used in conjunction with the specification to explain the principles of the present disclosure.

FIG. 1 is a schematic diagram illustrating an exemplary order allocation system according to some embodiments of the present disclosure;

FIG. 2 is a block diagram of an exemplary processing device according to some embodiments of the present disclosure;

FIG. 3 is a flowchart illustrating an exemplary process of order allocation according to some embodiments of the present disclosure;

FIG. 4 is a flowchart illustrating a process for determining whether a service requester is a frequent user according to some embodiments of the present disclosure;

FIG. 5 is a flowchart illustrating a process for determining whether a service requester is a potentially frequent user according to some embodiments of the present disclosure; and

FIG. 6 is a flowchart illustrating a process for determining whether a service request is a potentially frequent user according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof. It should be understood that although the terms first, second, third, etc. are used in the present disclosure to describe various forms of information, such information should not be limited to these terms. These terms are only used to distinguish the same type of information from one another.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding allocating orders of an O2O service, it should also be understood that this is only for illustration purpose. The systems or methods of the present disclosure may be applied to any kind of service platform. For example, the systems or methods of the present disclosure may be applied to different transportation systems including land transportation system, ocean transportation system, aerospace transportation system, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation systems may perform functions of object management and/or distribution, for example, the function of sending and/or receiving an express, the function of delivering food. The application scenarios of the systems or methods of the present disclosure may include a webpage, a plug-in of a browser, a client terminal, a custom system, an Internal analysis system, an artificial intelligence robot, or the like, or any combination thereof.

It should be noted that O2O services, such as online taxi-hailing services, is a new form of services rooted only in post-Internet era. It provides detailed information about a user terminal that could raise only in post-Internet era. It provides technical solutions to service requesters and service providers that could raise only in post-Internet era. In pre-Internet era, when a service requester (e.g., a passenger) hails a taxi on the street, the taxi request and acceptance occur only when the passenger sees a taxi driver face to face. If the passenger hails a taxi through a telephone call, the service request and acceptance may occur only between the passenger and one taxi company or agent. O2O services, however, allows a user of the service to distribute a service request in real-time and automatically to a vast number of service providers (e.g., taxis). It also allows a plurality of service providers to respond to the service request simultaneously and in real-time. Therefore, through the Internet, the system may provide a much more efficient transaction platform for the service requesters and the service providers that may never meet in a traditional pre-Internet transportation service system.

In some embodiments, the systems may allocate an order requesting a second level of a service to a target service provider providing a first level of the service when it is difficult for the target service provider to receive the order(s) requesting the first level of the service. As such, by matching the orders and the service providers that are associated with different levels of the service, the systems may make the allocation of orders more efficiently, thus improving the utilization of the whole service resources. Furthermore, the systems may select the orders to be allocated in the way described above according to a certain screening criteria to achieve a certain goal. For example, in some occasions, the systems may select the order whose requester is an infrequent user of the first level of the service. By doing so, the systems can provide the first level of the service to the infrequent user of the first level of the service, which may promote the infrequent user to request the first level of the service more frequently in the future.

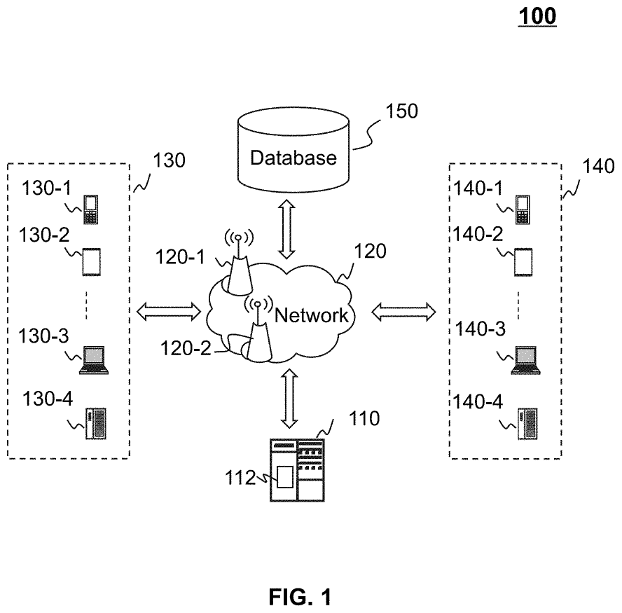

FIG. 1 is a schematic diagram illustrating an exemplary order allocation system according to some embodiments of the present disclosure.

In some embodiments, the order allocation system 100 may be an O2O service platform for different service types, such as an express service, a tailored car service, a hitchhiking service, a taxi hailing service, a chauffeur service, a carpool service, a bus service, a driver hire service, a shuttle service, or the like. As used herein, each of the different service types may have a specific service content and may be measured by its service quality and/or its charge strategy. For example, the express service may have similar service content as the tailored car service, both of which may include transporting a passenger from a pick-up point to a destination. However, the charge strategies of these two service types may be different due to different service qualities. Specifically, the tailored car service may be more expensive than the express service since the tailored car service can provide a more comfortable riding environment than the express service. In some embodiments, different service types, providing similar contents but with different service qualities and/or charge strategies, may be referred to as different levels of a service (e.g., the car service). For example, for various car services, the tailored car service may be regarded as an example of a first level of the service, and the express service may be regarded as a second level of the service. In some embodiments, for brevity, the terms “first level of a service” and “first service type” may be used interchangeably, and the terms “second level of a service” and “second service type” may also be used interchangeably.

The order allocation system 100 may include a server 110, a network 120, a requester terminal 130, a provider terminal 140, and a database 150. It should be understood that the number or types of the servers, the network, the requester terminals, the provider terminals, and the database in FIG. 1 are merely provided for illustration purpose. Depending on the actual needs, there may be any number or types of servers, network, requester terminals, provider terminals, and database.

In some embodiments, the server 110 may be a single server, or a server group. The server group may be centralized, or distributed (e.g., the server 110 may be a distributed system). In some embodiments, the server 110 may be local to or remote from other components of the order allocation system 100. For example, the server 110 may access information and/or data stored in the requester terminal 130, the provider terminal 140, and/or the database 150 via the network 120. As another example, the server 110 may be directly connected to the requester terminal 130, the provider terminal 140, and/or the database 150 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components.

In some embodiments, the server 110 may include a processing device 112. The processing device 112 may process information and/or data relating to the service request to perform one or more functions of the server 110 described in the present disclosure. For example, the processing device 112 may allocate a target order requesting a second service type (e.g., a second level of a service) to a service provider providing a first service type (e.g., a first level of the service). As another example, the processing device 112 may also identify the target order requesting the second service type from a requester based on a screening criteria that at least includes that the requester is an infrequent user of the first service type.

In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the order allocation system 100 (e.g., the server 110, the requester terminal 130, the provider terminal 140, and/or the database 150) may transmit information and/or data to other component(s) in the order allocation system 100 via the network 120. For example, the server 110 may obtain/acquire service request data from the requester terminal 130 via the network 120. In some embodiments, the network 120 may be any type of wired or wireless network, or a combination thereof. Merely by way of example, the network 120 may include a cable network, a wireline network, an optical fiber network, a telecommunication network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, an ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the order allocation system 100 may be connected to the network 120 to exchange data and/or information.

The requester terminal 130 may be used by a passenger to request an O2O service. For example, a user of the requester terminal 130 may use the requester terminal 130 to send a service request for himself/herself or another user, or receive service information or instructions from the server 110. The provider terminal 140 may be used by a user of the service provider to reply an O2O service. For example, a driver may use the provider terminal 140 to accept a service request from the requester terminal 130, and/or information or instructions from the server 110. In some embodiments, the terms “user,” “passenger,” “customer,” “service requestor,” and “service requester” may be used interchangeably, and the terms “user,” “driver,” and the “service provider” may be used interchangeably. In some embodiments, the user may refer to a service requester or a service provider according to a specific situation. In some embodiments, the terms “user terminal,” “passenger terminal,” “requester terminal,” and “requestor terminal” may be used interchangeably. In some embodiments, the terms “user terminal,” “driver terminal,” and “provider terminal” may be used interchangeably.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, the built-in device in the motor vehicle 130-4 may include an onboard computer, an onboard television, etc. In some embodiments, the requester terminal 130 may be a wireless device with positioning technology for locating the position of the user and/or the requester terminal 130.

In some embodiments, the requester terminal 130 may further include at least one network port. Via the at least one network port, the requester terminal 130 may be configured to send information to and/or receive information from one or more components in the order allocation system 100 (e.g., the server 110, the database 150) via the network 120.

In some embodiments, the provider terminal 140 may include a mobile device 140-1, a tablet computer 140-2, a laptop computer 140-3, a built-in device in a motor vehicle 140-4, or the like, or any combination thereof. In some embodiments, the mobile device 140-1 may include a smart home device, a wearable device, a smart mobile device, a virtual reality device, an augmented reality device, or the like, or any combination thereof. In some embodiments, the provider terminal 140 may be similar to, or the same device as the requester terminal 130. In some embodiments, the provider terminal 140 may be a wireless device with positioning technology for locating the position of the driver and/or the provider terminal 140. In some embodiments, the requester terminal 130 and/or the provider terminal 140 may communicate with other positioning device to determine the position of the passenger, the requester terminal 130, the driver, and/or the provider terminal 140. In some embodiments, the requester terminal 130 and/or the provider terminal 140 may transmit positioning information to the server 110.

In some embodiments, the provider terminal 140 may further include at least one network port. Via the at least one network port, the provider terminal 140 may be configured to send information to and/or receive information from one or more components in the order allocation system 100 (e.g., the server 110, the database 150) via the network 120.

The database 150 may store data and/or instructions. In some embodiments, the database 150 may store data obtained/acquired from the requester terminal 130 and/or the provider terminal 140. In some embodiments, the database 150 may store data and/or instructions that the server 110 may execute or use to perform exemplary methods described in the present disclosure. In some embodiments, the database 150 may include a mass storage device, a removable storage device, a volatile read-and-write memory, a read-only memory (ROM), or the like, or any combination thereof. Exemplary mass storage device may include a magnetic disk, an optical disk, a solid-state drive, etc. Exemplary removable storage device may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may include at least one network port to communicate with other devices or components in the order allocation system 100. For example, the database 150 may be connected to the network 120 to communicate with one or more components in the order allocation system 100 (e.g., the server 110, the requester terminal 130, the provider terminal 140, etc.) via the at least one network port. One or more components in the order allocation system 100 may access the data or instructions stored in the database 150 via the network 120. In some embodiments, the database 150 may be directly connected to or communicate with one or more components in the order allocation system 100 (e.g., the server 110, the requester terminal 130, the provider terminal 140, etc.). In some embodiments, the database 150 may be part of the server 110.

In some embodiments, one or more components in the order allocation system 100 (e.g., the server 110, the requester terminal 130, the provider terminal 140, etc.) may have a permission to access the database 150. In some embodiments, one or more components in the order allocation system 100 may read and/or modify information related to the passenger, driver, and/or the public when one or more conditions are met. For example, the server 110 may read and/or modify one or more users' information after a service. As another example, the provider terminal 140 may access information related to the passenger when receiving a service request from the requester terminal 130, but the provider terminal 140 may not modify the relevant information of the passenger.

In some embodiments, one or more components of the order allocation system 100 (e.g., the server 110, the requester terminal 130, the provider terminal 140, or the database 150) may communicate with each other in the form of electronic and/or electromagnetic signals, through wired and/or wireless communication. In some embodiments, the order allocation system 100 may further include at least one first information exchange port corresponding to a service requesting system and at least one second information exchange port corresponding to a service providing system. The service requesting system may include the requester terminal 130 and the network 120. The service providing system may include the provider terminal 140 and the network 120. Via the at least one first information exchange port, information relating to the service request (e.g., in the form of electronic signals and/or electromagnetic signals) may be exchanged between any electronic devices in the order allocation system 100. For example, via the at least one first information exchange port, the server 110 may receive an order from a requester terminal 130 through wireless communication between the server 110 and the provider terminal 130. Via the at least one second information exchange port, information (e.g., in the form of electronic signals and/or electromagnetic signals) may be exchanged between any electronic devices in the order allocation system 100. For example, via the at least one second information exchange port, the server 110 may send electromagnetic signals including information of the allocated orders to the provider terminal 140 through wireless communication. In some embodiments, the at least one first information exchange port and/or the at least one second information exchange port may be one or more of an antenna, a network interface, a network port, or the like, or any combination thereof. For example, the at least one first information exchange port and/or the at least one second information exchange port may be a network port connected to the server 110 to transmit and/or receive information.

In some embodiments, information exchanging of one or more components in the order allocation system 100 may be achieved by way of requesting a service. The object of the service request may be any product. In some embodiments, the product may be a tangible product, an intangible product, a service, etc. The tangible product may include food, medicine, commodity, chemical product, electrical appliance, clothing, car, housing, luxury, or the like, or any combination thereof. The intangible product may include a financial product, a knowledge product, an Internet product, or the like, or any combination thereof. The Internet product may include an individual host product, a web product, a mobile Internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skills in the art would understand that when an element of the order allocation system 100 performs a function, the element may perform the function through electrical signals and/or electromagnetic signals. For example, when a requester terminal 130 processes a task, such as sending a service request, the requester terminal 130 may operate logic circuits in its processor to perform such task. When the requester terminal 130 transmits the service request to the server 110, a processor of the server 110 may generate electrical signals encoding the service request. The processor of the server 110 may then transmit the electrical signals to at least one first information exchange port of a first target system (e.g., a service requesting system) associated with the server 110. The server 110 may communicate with the service requesting system via a wired network, the at least one first information exchange port may be physically connected to a cable, which may further transmit the electrical signals to an input port (e.g., an information exchange port) of the requester terminal 130. If the server 110 communicates with the service requesting system via a wireless network, the at least one first information exchange port of the service requesting system may be one or more antennas, which may convert the electrical signal to an electromagnetic signal. Similarly, a provider terminal 140 may process a task through operation of logic circuits in its processor, and receive an instruction and/or service request from the server 110 in the form of an electrical signal or an electromagnetic signal. A processor of the server 110 may generate electrical signals encoding information of allocating orders and transmit the electrical signals to at least one second information exchange port of a second target system (e.g., a service providing system) associated with the server 110. The server 110 may communicate with the service providing system via a wired network, and the at least one second information exchange port may be physically connected to a cable, which may further transmit the electrical signals to an input port (e.g., an information exchange port) of the provider terminal 140. If the server 110 communicates with the service providing system via a wireless network, the at least one second information exchange port of the service providing system may be one or more antennas, which may convert the electrical signal to an electromagnetic signal. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves data from or saves data in a storage medium, it may transmit out electrical signals to a read/write device of the storage medium, which may read and/or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

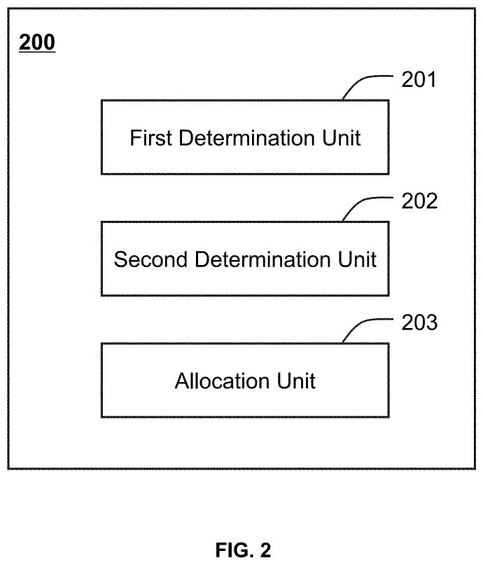

FIG. 2 is a block diagram of an exemplary processing device 200 according to some embodiments of the present disclosure. The processing device 200 may include a first determination unit 201, a second determination unit 202, and an allocation unit 203. In some embodiments, the processing device 200 may be implemented on the processing device 112 in the server 110. The units may be hardware circuits of at least part of the processing device 112. In some embodiments, the units may be implemented as an application or set of instructions read and executed by the processing device 112. Further, the units may be any combination of the hardware circuits and the application/instructions. For example, the units may be part of the processing device 112 when the processing device 112 is executing the application/set of instructions.

The first determination unit 201 may be configured to identify a service provider providing a first service type (e.g., a first level of a specific service) to whom an order requesting a second service type (e.g., a second level of the specific service) is to be allocated. In some embodiments, the first determination unit 201 may be configured to determine to allocate an order requesting the second service type to a target service provider providing the first service type.

In some embodiments, the first service type and the second service type may be O2O services. For example, both the first service type and the second service type may be O2O services of vehicles. The vehicles may include a carriage, a rickshaw (e.g., a wheelbarrow, a bike, a tricycle, a motor bike), a car (e.g., a taxi, a bus, a private car, a truck), a train, a subway, a vessel, an aircraft (e.g., an airplane, a helicopter, a space shuttle, a rocket, a hot-air balloon), or the like, or any combination thereof. It shall be noted that the disclosure may not limit the specific form or type of the first service type and the second service type. The first service type and the second service type may include any other service, such as various types of electronic commerce services and/or traditional commerce services.

In some embodiments, the first service type and the second service type may be services provided by different service operators. The different service operators may be two or more companies that provide the same or similar service contents.

In some embodiments, the first determination unit 201 may identify whether a service provider providing a first service type (e.g., a first level of a car service) is available to provide a second service type (e.g., a second level of the car service). If the service provider providing the first service type does not receive any order requesting the first service type in a preset time period, the service provider may be regarded as available to provide the second service type and identified as a target service provider. Then the first determination unit 201 may determine to allocate an order requesting the second service type to the target service provider. For example, taking the O2O service of vehicles as an example, if a driver providing the tailored car service does not receive any order requesting the tailored car service (i.e., the first level of the car service) in a preset time period (e.g., 20 minutes), the first determination unit 201 may determine to allocate an order requesting express service (i.e., the second level of the car service) to the driver.

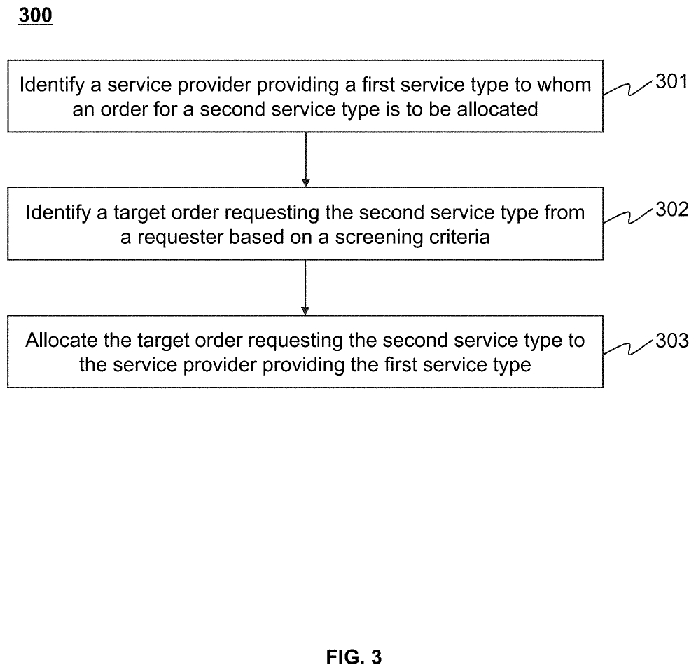

The second determination unit 202 may be configured to identify a target order requesting the second service type to be allocated to the service provider providing the first service type. The target order may be determined based on information of the service requester requesting the second service type and a screening criteria. In some embodiments, the screening criteria may at least include that the service requester is an infrequent user of the first service type. More descriptions regarding the screening criteria may be found elsewhere in the present disclosure (e.g., FIG. 3 and the descriptions thereof).

The allocation unit 203 may be configured to allocate the target order requesting the second service type to a service provider providing the first service type.

In some embodiments, the allocation unit 203 may allocate the target order to the service provider at least partially in response to determining that the service requester is an infrequent user of the first service type. Additionally or alternatively, the allocation unit 203 may further determine whether the service requester is a potentially frequent user of the first service type, and allocate the target order to the service provider on occurrence that the service requester is the potentially frequent user of the first service type.

In some alternative embodiments, the allocation unit 203 may include a determination sub-unit and an allocation sub-unit (not shown in FIG. 2).

The determination sub-unit may be configured to determine whether the service requester is a potentially frequent user of the first service type. A potentially frequent user of the first service type may be a user who is likely to be converted from the infrequent user of the first service type to the frequent user of the first service type after using the first service type one or more times.

The allocation sub-unit may be configured to allocate the target order to the service provider on occurrence that the service requester is a potentially frequent user of the first service type.

In some embodiments, the apparatus may further include an obtaining unit (not shown in FIG. 2).

The obtaining unit may be configured to obtain target data of a service requester. In some embodiments, the target data may include the historical orders of the service requester in a preset time period. The preset time period may be any reasonable time period, for example, the last month, the last three months, or the last year, etc.

In some embodiments, the second determination unit 202 may determine whether the service requester is a frequent user of the first service type based on the target data. For example, the second determination unit 202 may determine a count of orders for the first service type or a proportion of orders for the first service type in the historical orders based on the target data. Then, the second determination unit 202 may determine that the service requester is the frequent user if the count of orders for the first service type or the proportion of orders for the first service type is greater than or equal to a preset threshold. Taking the O2O service of vehicles as an example, firstly, according to the target data including historical orders of a passenger in a preset time period, the second determination unit 202 may determine a count of orders for tailored car service initiated by the passenger in the historical orders. Then, the second determination unit 202 may determine whether the count of the orders for tailored car service is greater than or equal to the preset threshold. If the count of the orders for tailored car service is greater than or equal to the preset threshold, the second determination unit 202 may determine that the passenger is a frequent user of the tailored car service. Otherwise, the second determination unit 202 may determine that the passengers is an infrequent user of the tailored car service.

The units in the processing device 200 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth™ network, a ZigBee™ network, a Near Field Communication (NFC), or the like, or any combination thereof. In some embodiments, the processing device 200 may also include other units. In some embodiments, the first determination unit 201, the second determination unit 202 and the allocation unit 203 may be implemented on different processors in the server 110. In some embodiments, the first determination unit 201, the second determination unit 202 and the allocation unit 203 may be implemented on a single processor in the server 110.

FIG. 3 is a flowchart illustrating a process 300 of order allocation according to some embodiments of the present disclosure. In some embodiments, the process 300 may be performed by the order allocation system 100. For example, the process 300 may be stored in the database 150 as a form of instructions, and invoked and/or executed by the server 110 (e.g., the processing device 112 in the server 110). The operations of the illustrated process presented below are intended to be illustrative. In some embodiments, the process 300 may be accomplished with one or more additional operations not described, and/or without one or more of the operations discussed. Additionally, the order of the operations of the process 300 as illustrated in FIG. 3 and described below is not intended to be limiting.

In 301, the server 110 (e.g., the first determination unit 201 of the processing device 112) may identify a service provider providing a first service type to whom an order for a second service type is to be allocated. In some embodiments, if the first service type and the second service type provide services with similar contents (e.g., both provide the car service), the first service type may be referred to as the first level of a service (e.g., the tailored car service of the car service), and the second service type may be referred to as the second level of the service (e.g., the express service of the car service). The service provider to whom the order for the second service type is to be allocated may be a service provider that is available to provide the second service type if allocated.

In some embodiments, the first service type and the second service type may be O2O services. In some embodiments, the O2O services may provide various products, including tangible products and intangible products. Exemplary tangible product may include a food, a medicine, a commodity, a chemical product, an electrical appliance, a clothing, a housing, a luxury, or the like, or any combination thereof. Exemplary intangible product may include a financial product, a knowledge product, an Internet product, or the like, or any combination thereof. The Internet product may include an individual host product, a web product, a mobile Internet product, a commercial host product, an embedded product, or the like, or any combination thereof. Optionally, both the first service type and the second service type may be O2O services of vehicles as described elsewhere in the present disclosure.

In some embodiments, the first service type and/or the second service type may be other services, such as various types of electronic commerce services and/or traditional commerce services. The electronic commerce services may include a Business to Business service, a Business to Customer service, a Customer to Customer service, a Business to Marketing service, a Manufacturer to Consumer service, a Business to Administration service, or the like, or any combination thereof. The traditional commerce services may include services provided through traditional media (e.g., a telephone, a mail, a letter, a fax, etc.).

In some embodiments, the first service type and the second service type may have different pricing strategies and/or different service qualities. For example, the service quality of the first service type may be better than that of the second service type, and correspondingly, the service price of the first service type may be higher than that of the second service type. Taking the O2O service of vehicles as an example, the first service type may be a tailored car service with a higher service quality, and the second service type may be an express service with a lower service quality. The tailored car service (i.e., the first level of service) may be regarded as superior to the express service (i.e., the second level of service) in the aspect of, for example, the car's quality, the comfort level, etc. When transporting a passenger from the same starting point to the same destination point, the tailored car service may charge more than the express car service.

In some embodiments, the first service type and the second service type may be services characterized in different areas. Optionally, the first service type and the second service type may have similar service contents. Exemplary areas may include a geographical area, an administrative area, or an operation area, or the like, or any combination thereof. For example, the geographic areas may include areas divided based on geographic features such as the climate, the topography, the soil, the vegetation, or the like, or any combination thereof. The administrative areas may include a country, a province, a city, a county, a town, a township, a street, or the like, or any combination thereof. The operation areas may be areas divided by service operators according to their business needs. In some embodiments, the different areas may have different amounts of order requests. Taking the O2O service of vehicles as an example, the first service type may be a car service in a first area with a small number of order requests, and the second service type may be a car service in a second area with a large number of order requests.

In some embodiments, the first service type and the second service type may be services provided by different service operators. The different service operators may be two or more companies that provide the same or similar service contents. For example, the different service operators may be cooperative companies, parent companies and subsidiaries, or the like, or any combination thereof. Taking the O2O service of vehicles as an example, the first service type may be a car service of a first company (or first operator) having a small number of order requests, and the second service type may be a car service of a second company (or second operator) having a large number of order requests.

In some embodiments, the server 110 (e.g., the first determination unit 201 of the processing device 112) may identify the service provider providing the first service type when the service provider does not receive an order requesting the first service type in a preset time period. For brevity, the identified service provider may be referred to as a target service provider. Then, the server 110 may determine to allocate an order requesting a second service type to the target service provider. For example, taking the O2O service of vehicles as an example, if a driver providing the tailored car service does not receive any order requesting the tailored car service in a preset time period (e.g., 20 minutes), the server 110 may determine to allocate the order requesting the express service to that driver.

In some embodiments, the first service type and the second service may be services characterized in different areas. In such cases, the server 110 (e.g., the first determination unit 201 of the processing device 112) may identify a service provider in a first area (i.e., providing the first service type) to whom an order in a second area (i.e., an order for the second service type) is to be allocated. For example, the server 110 (e.g., the first determination unit 201 of the processing device 112) may identify a service provider in the first area when the difference of the amounts of order requests between the first area and the second area exceeds a preset threshold. The preset threshold may be a certain number (e.g., 100, 300, 500) or a percentage (e.g., 30%, 50%) of the amount of order requests. The identified service provider may be referred to as the target service provider. Then the server 110 (e.g., the first determination unit 201 of the processing device 112) may determine to allocate an order for the second service type to the target service provider. For example, taking the O2O service of vehicles as an example, if the amount of order requests in a first area is less than 50% of that in a second area, the server 110 (e.g., the first determination unit 201 of the processing device 112) may determine to allocate a certain number of order requests in the second area to the service providers in the first area. The certain number of order requests in the second area to be allocated may be determined according to a specific rule. Optionally, the different areas may be adjacent areas or areas close to each other, thus making the allocation more convenient and efficient.

In some embodiments, the first service type and the second service type may be services provided by different service operators (or companies). The server 110 (e.g., the first determination unit 201 of the processing device 112) may identify a service provider for a first service type to whom an order for a second service type is to be allocated when there are different amounts of order requests for the different service operators. For example, the server 110 (e.g., the first determination unit 201 of the processing device 112) may identify a service provider for a first service type corresponding to a first service operator when the difference of the amounts of order requests between the different service operators exceeds a preset threshold. The preset threshold may be a certain number (e.g., 100, 300, 500) or a percentage (e.g., 30%, 50%) of the amount of order requests. The identified service provider may be referred to as the target service provider. Then the server 110 (e.g., the first determination unit 201 of the processing device 112) may determine to allocate an order for a second service type corresponding to a second service operator to the target service provider. For example, taking the O2O service of vehicles as an example, if the amount of order requests of the first operator is less than 50% of that of the second operator, the server 110 (e.g., the first determination unit 201 of the processing device 112) may determine to allocate a certain number of order requests of the second operator to the service providers of the first operator. The certain number of order requests of the second operator to be allocated may be determined according to a specific rule.

In 302, the server 110 (e.g., the second determination unit 202 of the processing device 112) may identify a target order requesting the second service type from a requester based on a screening criteria.

In some embodiments, the target order to be allocated may be an order selected from a plurality of orders requesting the second service type. Taking the O2O service of vehicles as an example, the target order may be an order for express service, and the requester of the target order may be a passenger requesting that order. The screening criteria may screen out the target order from the plurality of orders based on the information of the corresponding requesters. For example, the screening criteria may at least include that the requester of the target order is an infrequent user of the first service type.

In some embodiments, the frequent user of the first service type may be a user who uses the first service type frequently. The server 110 may mark the frequent users of the first service type in real-time or at a certain time period. When determining whether the service requester is a frequent user of the first service type, the server 110 (e.g., the second determination unit 202 of the processing device 112) may directly check whether the service requester has a frequent user mark. If the service requester has a frequent user mark, the service requester may be regarded as the frequent user of the first service type. Otherwise, the service requester may be regarded as the infrequent user of the first service type.

In some embodiments, the server 110 (e.g., the second determination unit 202 of the processing device 112) may retrieve historical orders of the service requester in a preset time period, and determine a count of orders for the first service type or a proportion of orders for the first service type in the historical orders. The server 110 may further determine that the service requester is an infrequent user of the first service type on occurrence that the count of orders for the first service type or the proportion of orders for the first service type in the historical orders is less than a first threshold.

In some embodiments, the screening criteria may further include that the service requester is a potentially frequent user of the first service type. For example, the server 110 (e.g., the second determination unit 202 of the processing device 112) may extract feature information of the historical orders of the service requester, and input the extracted feature information into a trained model to obtain an output result that indicates whether the service requester is the potentially frequent user of the first service type.

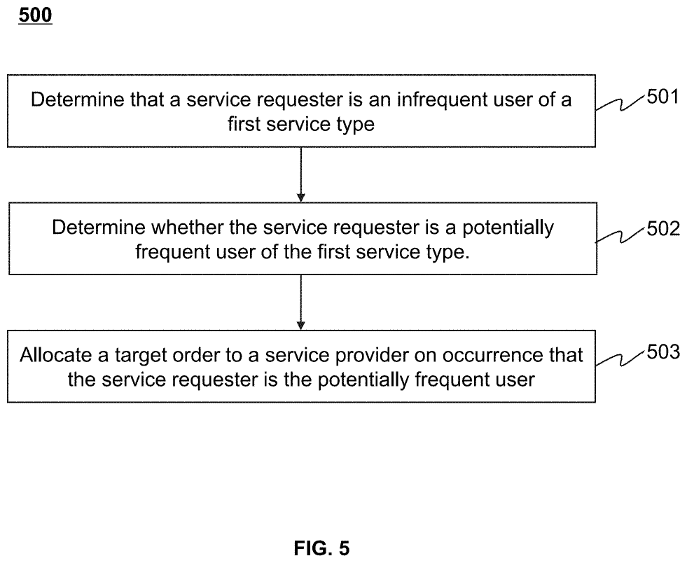

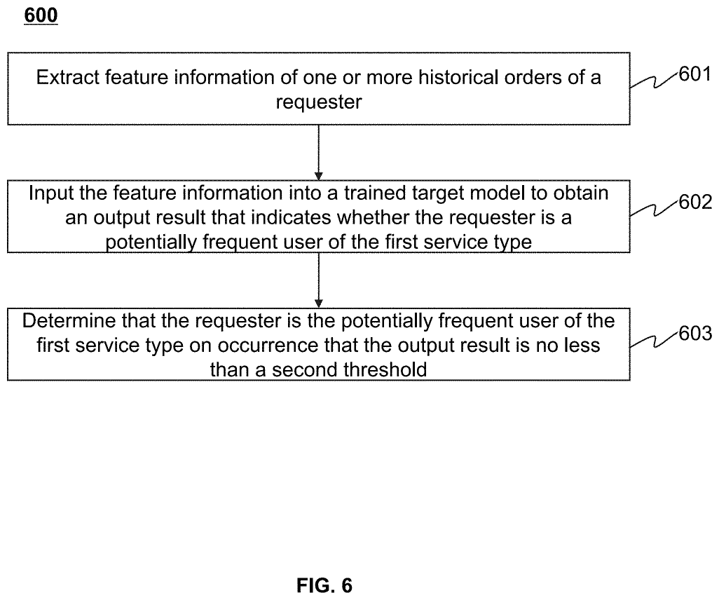

In some embodiments, the screening criteria may also incorporate other information related to a user (e.g., a service requester, a service provider). The other information related to the user may include an account level, an experience value of the account, a displayed name (e.g., a nickname), the age, the gender, a telephone number, a brand of a telephone of the user, an occupation, a profile image, a documentation number (e.g., an identification number), a third-party account (e.g., an email account), habits/preferences, a criminal record, locations that are often accessed by the user (e.g., a hotel, a guesthouse, a bar, a KTV club), a count of orders accepted and subsequently cancelled by the user within a specific period of time (e.g., the past week(s), the past month(s), the past year(s)), a count and/or frequency of complaints submitted by the user or a count and/or frequency the user has been complained within a specific period of time (e.g., the past week(s), the past month(s), the past year(s)), information posted on forums, blogs, or social networks by the user or relating to the user, or the like, or any combination thereof. More descriptions about the screening criteria associated with the information related to a user may be found elsewhere in the present disclosure (e.g., FIGS. 5, 6 and the descriptions thereof).

It should be understood that the server 110 (e.g., the second determination unit 202 of the processing device 112) may determine whether the service requester is a frequent user of the first service type by other means, which may not be limited in the disclosure.

In 303, the server 110 (e.g., the allocation unit 203 of the processing device 112) may allocate the target order requesting the second service type to the service provider providing the first service type.

In some embodiments, the server 110 (e.g., the allocation unit 203 of the processing device 112) may allocate the target order to the identified service provider (i.e., the target service provider) at least partially in response to determining that the service requester is an infrequent user of the first service type. For example, the server 110 (e.g., the allocation unit 203 of the processing device 112) may directly allocate the target order requesting the second service type to the identified service provider after determining that the service requester is the infrequent user of the first service type. Additionally, the server 110 may further determine whether the service requester is a potentially frequent user of the first service type after determining that the service requester is the infrequent user of the first service type. The server 110 may allocate the target order to the target service provider on occurrence that the service requester is the potentially frequent user of the first service type.

Specifically, in some occasions, the server 110 (e.g., the allocation unit 203 of the processing device 112) may determine to allocate an order requesting express service to a driver providing tailored car service, when the driver does not receive any order requesting tailored car service in 20 minutes. Firstly, the server 110 may determine whether the passenger corresponding to the order requesting express service is a frequent user of the tailored car service (i.e., whether the passenger often uses the tailored car service). If the passenger is an infrequent user of the tailored car service, the server 110 may allocate the order requesting express service to the driver. Additionally or alternatively, if the passenger is an infrequent user of the tailored car service, the server 110 may further determine whether the passenger is a potentially frequent user of the tailored car service. If the passenger is the potentially frequent user of the tailored car service, the server 110 may allocate the order requesting express service to the driver providing tailored car service.

In some embodiments, another specific application scenario may be that the server 110 (e.g., the allocation unit 203 of the processing device 112) may determine to allocate an order in a second area (i.e., the second service type) to a service provider in a first area (i.e., the first service type) when the amount of order requests in the first area is less than a specific value (e.g., 50%) of that of the second area. Firstly, the server 110 may determine whether the passenger corresponding to the order in the second area is a frequent user of the service provided in the first area (i.e., whether the passenger often uses the services provided in the first area). If the passenger is an infrequent user of the service provided in the first area, the server 110 (e.g., the allocation unit 203 of the processing device 112) may allocate the order in the second area to the service provider in the first area. Alternatively or additionally, if the passenger is an infrequent user of the service provided in the first area, the server 110 may further determine whether the passenger is a potentially frequent user of the service provided in the first area. If the passenger is a potentially frequent user of the service provided in the first area, the server 110 may allocate the order in the second area to the service provider in the first area.

In some embodiments, still another specific application scenario may be that the server 110 (e.g., the allocation unit of the processing device 112) may determine to allocate an order of a second company (or operator) to a service provider of a first company when the amount of order requests of the first company (or operator) is less than a specific value (e.g., 50%) of that of the second company (or operator). Firstly, the server 110 may determine whether the passenger corresponding to the order of the second company (or operator) to be allocated is a frequent user of the service provided by the first company (or operator) (i.e., whether the passenger often uses the service provided by the first company (or operator)). If the passenger is an infrequent user of the service provided by the first company (or operator), the server 110 (e.g., the allocation unit 203 of the processing device 112) may allocate the order of the second company (or operator) to the service provider of the first company (or operator). Alternatively or additionally, if the passenger is an infrequent user of the service provided by the first company (or operator), the server 110 may further determine whether the passenger is a potentially frequent user of the service provided by the first company (or operator). If the passenger is a potentially frequent user of the service provided by the first company (or operator), the server 110 may allocate the order of the second company (or operator) to the service provider of the second company.

In some embodiments, the server 110 may send a message to the user (e.g., the service provider, the service requester) before allocating the target order requesting the second service type to the service provider providing the first service type. The message may be in various forms, such as a text message, a voice, a picture, a telephone call, or the like, or any combination thereof. The message may be used for interaction between the server 110 and the user. For example, the server 110 may send a message to a requester requesting express service (e.g., the requester terminal 130) to notify the requester that his/her order may be allocated to a service provider providing tailored car service. For another example, the server 110 may send a message to a service provider providing tailored car service (e.g., the provider terminal 140) to notify the service provider that an order requesting express service may be allocated to him/her. Additionally, the user may click on the screen of his/her user terminal or send back another message to accept or reject the allocation.

It shall be noted that the descriptions above are non-limiting, and may be applied to various scenarios. In one aspect, the allocation of an order of a second service type to a service provider for a first service type may offer extra business opportunities to the service provider when no order requesting the first service type is available, thus reducing the empty-loaded rate of the service provider and improving the utilization of the service resources. In another aspect, the probability of the requester using the first service type in the future may be increased after the requester experiences the first service types one or more times.

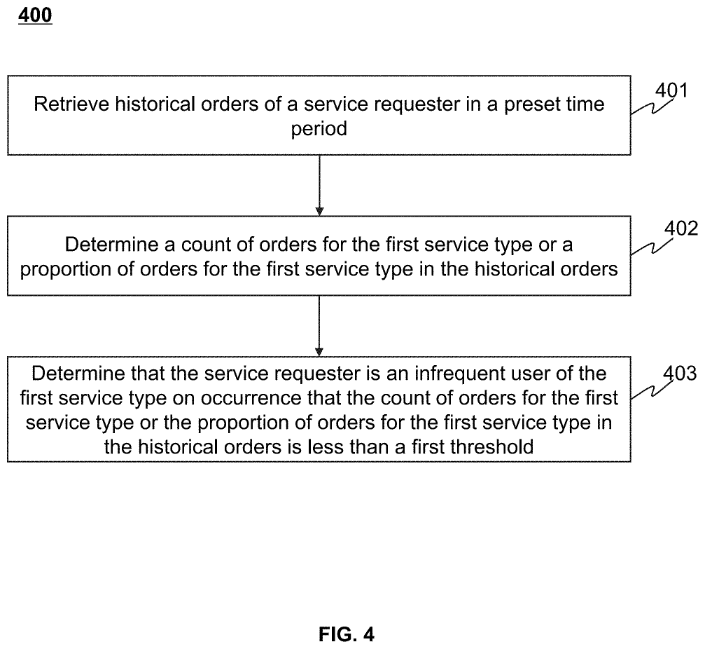

FIG. 4 is a flowchart illustrating a process 400 for determining whether a service requester is a frequent user according to some embodiments of the present disclosure. In some embodiments, the process 400 may be implemented in the order allocation system 100. For example, the process 400 may be stored in the database 150 as a form of instructions, and invoked and/or executed by the server 110 (e.g., the processing device 112 in the server 110). The operations of the illustrated process presented below are intended to be illustrative. In some embodiments, the process 400 may be accomplished with one or more additional operations not described, and/or without one or more of the operations discussed. Additionally, the order of the operations of the process 400 as illustrated in FIG. 4 and described below is not intended to be limiting. In some embodiments, the operation 302 may be performed according to the process 400.

In 401, the server 110 (e.g., the obtaining unit of the processing device 112) may retrieve historical orders of a service requester in a preset time period. The historical orders may be orders that were initiated by the service requester. In some embodiments, the server 110 (e.g., the obtaining unit of the processing device 112) may retrieve the historical orders of the service requester in the preset time period from the database 150, other storage device in the server 110, or an external storage device of the order allocation system 100. In some embodiments, the server 110 (e.g., the obtaining unit of the processing device 112) may retrieve the historical orders of the service requester in the preset time period at every preset interval (e.g., 1 second, 30 seconds, 1 minute, 5 minutes, 10 minutes).

In some embodiments, the server 110 (e.g., the obtaining unit of the processing device 112) may obtain target data associated with the service requester in the preset time period. The target data may include various information related to the historical activities of the service requester. The preset time period may be any reasonable time period, such as, the last month, the last three months, the last year, or the last five years, etc., which is not limited in this disclosure.

In some embodiments, the target data may include the total amount of historical orders of the service requester in the preset time period, the service type corresponding to each of the historical orders, the service charge corresponding to each of the historical orders, the service evaluation corresponding to each of the historical orders, the service area corresponding to each of the historical orders, the service operator (or company) corresponding to each of the historical orders, or the like, or any combination thereof. Taking the O2O service of vehicles as an example, the service type corresponding to a historical order may include an express service, a tailored car service, a hitchhiking service, a taxi hailing service, a chauffeur service, a carpool service, a bus service, a driver hire service, a shuttle service, or the like. In some embodiments, the target data may further include a travel path corresponding to each historical order, a pick-up location corresponding to each historical order, a destination corresponding to each historical order, neighboring area(s) of the route of each historical order, a starting time of each historical order, an estimated time of arrival of each historical order, a real time of arrival of each historical order, or the like, or any combination thereof.

In some embodiments, the target data may further include information related to the service requester. Taking the O2O service of vehicles as an example, the information related to the service requester may include an account level of the service requester, an experience value of the account of the service requester, a displayed name (e.g., a nickname) of the service requester, the age of the service requester, the gender of the service requester, a telephone number of the service requester, a brand of a telephone of the service requester, an occupation of the service requester, a profile image of the service requester, a documentation number (e.g., an identification number), a third-party account (e.g., an email account), habits/preferences of the service requester, a criminal record of the service requester, locations that are often accessed by the service requester (e.g., a hotel, a guesthouse, a bar, a KTV club, etc.), a count of orders accepted and subsequently cancelled by the service requester within a specific period of time (e.g., the past week(s), the past month(s), the past year(s), etc.), a count and/or frequency of complaints submitted by the service requester, or a count and/or frequency the service requester has been complained within a specific period of time (e.g., the past week(s), the past month(s), the past year(s)), information posted on forums, blogs, or social networks by the service requester or relating to the service requester, or the like, or any combination thereof.

In 402, the server 110 (e.g., the second determination unit 202 of the processing device 112) may determine a count of orders for the first service type or a proportion of orders for the first service type in the historical orders.

In some embodiments, the server 110 (e.g., the second determination unit 202 of the processing device 112) may determine the count of orders for the first service type in the historical orders based on the target data. Taking the O2O service of vehicles as an example, the server 110 (e.g., the second determination unit 202 of the processing device 112) may determine the count of orders requesting tailored car service of a passenger in the historical orders included in the target data of the passenger.

In some embodiments, the server 110 (e.g., the second determination unit 202 of the processing device 112) may determine the proportion of orders for the first service type in the historical orders based on the target data. Taking the O2O service of vehicles as an example, the server 110 (e.g., the second determination unit 202 of the processing device 112) may determine the proportion of orders requesting tailored car service of a passenger in the historical orders included in the target data of the passenger.

In some embodiments, the server 110 (e.g., the second determination unit 202 of the processing device 112) may determine the count of orders for the first service type or the proportion of orders for the first service type in the historical orders by one or more algorithms or models. For example, by using the one or more algorithms or models, the server 110 (e.g., the second determination unit 202 of the processing device 112) may automatically classify the target data and determine the count of orders for the first service type or the proportion of orders for the first service type in the historical orders.

In 403, the server 110 (e.g., the second determination unit 202 of the processing device 112) may determine that the service requester is an infrequent user of the first service type on occurrence that the count of orders for the first service type or the proportion of orders for the first service type in the historical orders is less than a first threshold.

Taking the O2O service of vehicles as an example, the server 110 (e.g., the second determination unit 202 of the processing device 112) may determine whether the count or the proportion of the orders for tailored car service of a passenger is less than a first threshold. If the count or the proportion of the orders for tailored car service is less than the first threshold, the server 110 (e.g., the second determination unit 202 of the processing device 112) may determine that the passenger is an infrequent user of the tailored car service. The first threshold may be a default value in the order allocation system 100, or may be manually set by a user according to actual needs.

Correspondingly, the server 110 (e.g., the second determination unit 202 of the processing device 112) may determine that the service requester is the frequent user on occurrence that the count of orders for the first service type or the proportion of orders for the first service type is greater than or equal to the preset threshold.

In some embodiments, the server 110 (e.g., the second determination unit 202 of the processing device 112) may mark the frequent users of the first service type in real-time or at every certain time period. When determining whether the service requester corresponding to the target order is a frequency user of the first service type, the server 110 (e.g., the second determination unit 202 of the processing device 112) may directly check whether the service requester has a frequent user mark. If the service requester has the frequent user mark, the service requester may be regarded as the frequent user of the first service type. If the service requester does not have the frequent user mark, the service requester may be regarded as the infrequent user of the first service type.

It should be noted that the above description is merely provided for the purposes of illustration, and not intended to limit the scope of the present disclosure. For persons having ordinary skills in the art, multiple variations and modifications may be made under the teachings of the present disclosure. For example, operation 401 and operation 402 may be integrated into a single operation. As another example, operation 402 and operation 403 may be integrated into a single operation. However, these variations and modifications still remain in the scope of the present disclosure.

FIG. 5 is a flowchart illustrating a process 500 for determining whether a service requester is a potentially frequent user according to some embodiments of the present disclosure. In some embodiments, the process 500 may be implemented in the order allocation system 100. For example, the process 500 may be stored in the database 150 as a form of instructions, and invoked and/or executed by the server 110 (e.g., the processing device 112 in the server 110). The operations of the illustrated process presented below are intended to be illustrative. In some embodiments, the process 500 may be accomplished with one or more additional operations not described, and/or without one or more of the operations discussed. Additionally, the order of the operations of the process 500 as illustrated in FIG. 5 and described below is not intended to be limiting. In some embodiments, operation 303 may be performed based at least in part on the process 500.

In 501, the server 110 (e.g., the second determination unit 202 of the processing device 112) may determine that a service requester is an infrequent user of a first service type.

In some embodiments, the server 110 (e.g., the second determination unit 202 of the processing device 112) may determine that the service requester is an infrequent user of the first service type on occurrence that the count of orders for the first service type or the proportion of orders for the first service type in the historical orders of the service requester is less than a first threshold. For example, the server 110 (e.g., the second determination unit 202 of the processing device 112) may retrieve target data of the service requester that includes historical orders initiated by the service requester in a preset time period. The server 110 (e.g., the second determination unit 202 of the processing device 112) may determine the count of orders for the first service type or a proportion of orders for the first service type in the historical orders. The server 110 (e.g., the second determination unit 202 of the processing device 112) may further determine that the service requester is an infrequent user of the first service type on occurrence that the count of orders for the first service type or the proportion of orders for the first service type in the historical orders is less than a first threshold. Detailed description of determining that a service requester is an infrequent user of the first service type may be found elsewhere in the present disclosure (e.g., FIG. 4 and the related description).

In 502, the server 110 (e.g., the second determination unit 202 of the processing device 112) may determine whether the service requester is a potentially frequent user of the first service type. It shall be noted that an infrequent user of the first service type can be further classified into different categories, including a category of potentially frequent users of the first service type and a category of potentially infrequent users of the first service. A potentially frequent user of the first service type may be a user who is more likely to be converted from the infrequent user of the first service type to the frequent user of the first service type after using the first service type one or more times.

After determining that the service requester is an infrequent user of the first service type, the server 110 (e.g., the second determination unit 202 of the processing device 112) may determine whether the service requester is a potentially frequent user of the first service type based on the target data of the service requester. Specifically, the server 110 (e.g., the second determination unit 202 of the processing device 112) may determine each potentially frequent user of the first service type and mark the each potentially frequent user of the first service type with a potentially frequent user mark. When determining whether the service requester corresponding to a target order is a potentially frequent user of the first service type, the server 110 may directly check whether the service requester has a potentially frequent user mark. If the service requester has the potentially frequent user mark, the service requester may be regarded as a potentially frequent user of the first service type. If the service requester does not have the potentially frequent user mark, the service requester may not be regarded as the potentially frequent user of the first service type.

In some embodiments, the server 110 may obtain target data of the service requester that includes historical orders initiated by the service requester in a preset time period, and determine whether the service requester is the potentially frequent user of the first service type based on the target data. For example, the server 110 may extract feature information of the historical orders from the target data, and input the feature information of the historical orders into a trained model to obtain an output result that indicates whether the service requester is the potentially frequent user of the first service type. Detailed description of determining whether the service requester is a potentially frequent user of the first service type based on the trained model may be found elsewhere in the present disclosure (e.g., FIG. 6 and the related description).

In 503, the server 110 (e.g., the allocation unit 203 in the processing device 112) may allocate a target order to a service provider on occurrence that the service requester is the potentially frequent user. In some embodiments, the target order to be allocated may be an order for the second service type. Taking the O2O service of vehicles as an example, the target order may be an order requesting express service initiated by a passenger, and the passenger may be the potentially frequent user of the first service type (e.g., the tailored car service).

In some embodiments, the service provider to be allocated may only provide the first service type, and the server 110 may allocate the target order to the service provider when a certain condition is satisfied. For example, the server 110 (e.g., the allocation unit 203 of the processing device 112) may allocate the target order to the service provider if no order requesting the first service type is available to the service provider in a certain time period (e.g., 20 minutes). As another example, assuming that the target order is generated in a second area and the service provider is located in a first area, the server 110 (e.g., the allocation unit 203 of the processing device 112) may allocate the target order to the service provider if the amount of order requests in the first area is less than a preset ratio (e.g., 50%) of that of the second area. As still another example, assuming that the target order is an order of a second company (or operator) and the service provider is of a first company (or operator), the server 110 (e.g., the allocation unit 203 of the processing device 112) may allocate the target order to the service provider when the amount of order requests of the first company (or operator) is less than a preset ratio (e.g., 50%) of that of the second company (or operator).

Alternatively or additionally, the server 110 may send a message to the user (e.g., the service provider, the requester) before allocating the target order requesting the second service type to the service provider providing the first service type. The message may be in various forms, such as a text message, a voice, a picture, a telephone call, or the like, or any combination thereof. The message may be used for interaction between the server 110 and the user. For example, the server 110 may send a message to a requester requesting express service (e.g., the requester terminal 130) to notify the requester that his/her order may be allocated to a service provider providing tailored car service. For another example, the server 110 may send a message to a service provider providing tailored car service (e.g., the provider terminal 140) to notify the service provider that an order requesting express service may be allocated to him/her. Additionally, the user may click on the screen of his/her user terminal or send back another message to accept or reject the allocation.

It should be noted that the above description is merely provided for the purposes of illustration, and not intended to limit the scope of the present disclosure. For persons having ordinary skills in the art, multiple variations and modifications may be made under the teachings of the present disclosure. For example, operation 501 and operation 502 may be integrated into a single operation. As another example, operation 502 may be omitted. The server 110 may directly allocate the target order to the service provider when determining that the service requester is an infrequent user of the first service type. However, these variations and modifications still remain in the scope of the present disclosure.

FIG. 6 is a flowchart illustrating a process 600 for determining whether a service request is a potentially frequent user according to some embodiments of the present disclosure. In some embodiments, the process 600 may be implemented in the order allocation system 100. For example, the process 600 may be stored in the database 150 as a form of instructions, and invoked and/or executed by the server 110 (e.g., the processing device 112 in the server 110). The operations of the illustrated process presented below are intended to be illustrative. In some embodiments, the process 600 may be accomplished with one or more additional operations not described, and/or without one or more of the operations discussed. Additionally, the order of the operations of the process 600 as illustrated in FIG. 6 and described below is not intended to be limiting. In some embodiments, operation 502 may be performed according to the process 600.

In 601, the server 110 may extract feature information of one or more historical orders of a requester. The feature information of the one or more historical orders of the requester may include at least one of a total amount of the one or more historical orders of the requester, a distribution of orders for different service types in the one or more historical orders of the requester, service charges of the one or more of the historical orders of the requester, service evaluations of the one or more of the historical orders of the requester. The distribution of orders for different service types in the one or more historical orders of the requester may include the ratio of the orders for each service type (e.g., the express service, the tailored car service) in the one or more historical orders of the requester. The service evaluations of the one or more of the historical orders of the requester may include a count and/or frequency of complaints submitted by the service requester, a count and/or frequency the service requester has been complained, the content of the service evaluations, or the like, or a combination thereof.

In some additional embodiments, in the O2O service of vehicles, the feature information may further include one or more of: the travel path corresponding to each of the one or more historical orders, the pick-up location corresponding to each of the one or more historical orders, the destination corresponding to each of the one or more historical orders, the neighboring areas of the route corresponding to each of the one or more historical orders, the starting time corresponding to each of the one or more historical orders, the estimated time of arrival corresponding to each of the one or more historical orders, the real time of arrival corresponding to each of the one or more historical orders, or the like.

In 602, the server 110 may input the feature information into a trained target model to obtain an output result that indicates whether the requester is a potentially frequent user of the first service type.

In some embodiments, the server 110 may input the feature information into the trained target model to obtain an output probability value. For example, the output result may be a probability value (e.g., 70%), indicating the probability that the infrequent user becomes a frequent user of the first service type. In some embodiments, the server 110 may input the feature information into the trained target model to obtain an output numerical value. For example, the output result may be a numerical value (e.g., 0, 1), wherein the value 0 indicates that the requester is not a potentially frequent user of the first service type, and the value 1 indicates that the requester is a potentially frequent user of the first service type.

In some embodiments, the target model may include at least one of a Logistic Regression (LR) model, a Decision Tree model, or a Neural Network model.

Specifically, the target model may be trained as follows. Firstly, the server 110 may extract sample information of a plurality of sample requesters. The sample requesters may include positive samples and negative samples. Each positive sample may be assigned with a first sample value (e.g., 1) and each negative sample may be assigned with a second sample value (e.g., 0). The positive samples may be sample requesters who have transformed into frequent users of the first service type after a service upgrade has been provided to them in a certain time period. The negative samples may be sample requesters who have not transformed into frequent users of the first service type after a service upgrade has been provided to them in a certain time period. The service upgrade of the sample requesters may be that the server 110 (e.g., the allocation unit 203 in the processing device 112) allocates orders requesting the second service type initiated by the sample requesters to service providers who provide the first service type. The sample information may include historical orders of the sample requesters in a preset time period before the service upgrade.

Then, the server 110 may extract the sample feature information from the sample information. The sample feature information may include a total amount of the historical orders of the sample requester(s), a distribution of orders for different service types in the historical orders of the sample requester(s), service charges of the historical orders of the sample requester(s), or service evaluations of the historical orders of the sample requester(s), or the like, or a combination thereof. Additionally or alternatively, in the O2O service of vehicles, the sample feature information may further include one or more of: the travel path corresponding to each of the historical orders of the sample requester(s), the pick-up location corresponding to each of the historical orders of the sample requester(s), the destination corresponding to each of the historical orders of the sample requester(s), the neighboring areas of the route corresponding to each of the historical orders, the starting time corresponding to each of the historical orders of the sample requester(s), the estimated time of arrival corresponding to each of the historical orders of the sample requester(s), the real time of arrival corresponding to each of the historical orders of the sample requester(s), or the like, or any combination thereof.

Finally, the target model may be trained to obtain the trained target model based on the sample values and the sample feature information of the sample requesters. For example, the server 110 may use the sample feature information of the sample requesters as input of the target model, and compare the output of the target model with the respective sample value. The comparison result may be further used to adjust weights for one or more nodes (e.g., the node representing each sample feature information) included in the target model.

In 603, the server 110 (e.g., the allocation unit 203 in the processing device 112) may determine that the requester is the potentially frequent user of the first service type on occurrence that the output result is no less than a second threshold.

In some embodiments, the output result may be a probability value, and second threshold may be a preset probability value. The server 110 may determine that the service requester is the potentially frequent user if the output probability value is greater than or equal to the preset probability value. For example, assuming that the output probability value is 70% and the preset probability value is 60%, the server 110 may determine that the service requester is the potentially frequent user.

It should be noted that the above description is merely provided for the purposes of illustration, and not intended to limit the scope of the present disclosure. For persons having ordinary skills in the art, multiple variations and modifications may be made under the teachings of the present disclosure. For example, operation 601 and operation 602 may be integrated into a single operation. However, these variations and modifications still remain in the scope of the present disclosure.

It should be noted that the above description regarding the figures, the words, or the like, are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the words, such as “vehicle”, “taxi”, “express”, are merely provided for the purposes of illustration, and may be replaced by other words.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer-readable media having computer readable program code embodied thereon. The one or more computer-readable media may include ROM, RAM, magnetic disk, optical disk, or the like, or any combination thereof.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system, comprising:
at least one storage medium including a set of instructions for allocating orders in an on-demand service; and
logic circuits in communication with the at least one storage medium, wherein when executing the set of instructions, the logic circuits are to:
identify a service provider associated with a first level of a service, wherein the service provider is available to provide a second level of the service if allocated;
identify, based on a screening criteria, a target order requesting the second level of the service from a requester, the screening criteria including that the requester is an infrequent user of the first level of the service; and
allocate the target order to the service provider for providing the first level of the service.

2. The system of claim 1, wherein the first level of the service and the second level of the service are associated with at least one of different prices or different service qualities.

3. The system of claim 1, wherein to determine that the requester is an infrequent user of the first level of the service, the logic circuits are to:
retrieve historical orders of the requester;
determine a count of orders for the first level of the service or a proportion of orders for the first level of the service based on the historical orders; and
determine that the requester is an infrequent user of the first level of the service if the count of orders for the first level of the service or the proportion of orders for the first level of the service in the historical orders is smaller than a first threshold value.

4. The system of claim 3, wherein the screening criteria further includes that the requester is a potentially frequent user of the first level of the service.

5. The system of claim 4, wherein to determine that the requester is a potentially frequent user of the first level of the service, the logic circuits are directed to:
extract feature information of the historical orders of the requester;
input the feature information into a trained model to obtain an output result that indicates whether the requester is the potentially frequent user of the first level of the service; and
determine that the requester is the potentially frequent user of the first level of the service type if the output result is greater than a second threshold.

6. The system of claim 5, wherein the feature information of the historical orders of the requester comprises at least one of: a total amount of the historical orders of the requester, a distribution of orders for different service levels in the historical orders of the requester, service charges of one or more of the historical orders of the requester, or service evaluations of one or more of the historical orders of the requester.

7. The system of claim 5, wherein the trained model comprises at least one of a Logistic Regression (LR) model, a Decision Tree model, or a Neural Network model.

8. The system of claim 1, wherein the first level of the service and the second level of the service are both online to offline services of vehicles.

9. The system of claim 1, wherein the first level of the service is superior to the second level of the service.

10-27. (canceled)

28. A method implemented on a computing device having at least one storage medium including a set of instructions for allocating orders in an on-demand service, and logic circuits in communication with the at least one storage medium, the method comprising:
identifying a service provider associated with a first level of a service, wherein the service provider is available to provide a second level of the service if allocated;
identifying, based on a screening criteria, a target order requesting the second level of the service from a requester, the screening criteria including that the requester is an infrequent user of the first level of the service; and
allocating the target order to the service provider for providing the first level of the service.

29. The method of claim 28, wherein the first level of the service and the second level of the service are associated with at least one of different prices or different service qualities.

30. The method of claim 28, wherein to determine that the requester is an infrequent user of the first level of the service, the method comprises:
retrieving historical orders of the requester;
determining a count of orders for the first level of the service or a proportion of orders for the first level of the service based on the historical orders; and
determining that the requester is an infrequent user of the first level of the service if the count of orders for the first level of the service or the proportion of orders for the first level of the service in the historical orders is smaller than a first threshold value.

31. The method of claim 30, wherein the screening criteria further includes that the requester is a potentially frequent user of the first level of the service.

32. The method of claim 31, wherein to determine that the requester is a potentially frequent user of the first level of the service, the method comprises:
extracting feature information of the historical orders of the requester;
inputting the feature information into a trained model to obtain an output result that indicates whether the requester is the potentially frequent user of the first level of the service; and
determining that the requester is the potentially frequent user of the first level of the service type if the output result is greater than a second threshold.

33. The method of claim 32, wherein the feature information of the historical orders of the requester comprises at least one of: a total amount of the historical orders of the requester, a distribution of orders for different service levels in the historical orders of the requester, service charges of one or more of the historical orders of the requester, or service evaluations of one or more of the historical orders of the requester.

34. The method of claim 32, wherein the trained model comprises at least one of a Logistic Regression (LR) model, a Decision Tree model, or a Neural Network model.

35. The method of claim 28, wherein the first level of the service and the second level of the service are both online to offline services of vehicles.

36. The method of claim 28, wherein the first level of the service is superior to the second level of the service.

37. A non-transitory computer readable medium, comprising executable instructions that, when executed by logic circuits, direct the logic circuits to perform a method, the method comprising:
identifying a service provider associated with a first level of a service, wherein the service provider is available to provide a second level of the service if allocated;
identifying, based on a screening criteria, a target order requesting the second level of the service from a requester, the screening criteria including that the requester is an infrequent user of the first level of the service; and
allocating the target order to the service provider for providing the first level of the service.

38. The non-transitory computer readable medium of claim 37, wherein to determine that the requester is an infrequent user of the first level of the service, the method comprises:
retrieving historical orders of the requester;
determining a count of orders for the first level of the service or a proportion of orders for the first level of the service based on the historical orders; and
determining that the requester is an infrequent user of the first level of the service if the count of orders for the first level of the service or the proportion of orders for the first level of the service in the historical orders is smaller than a first threshold value.
